(19) United States
(12) Patent Application Publication
(10) Pub. No.: US 2022/0258571 A1
(43) Pub. Date: Aug. 18, 2022

(54) SYSTEM AND APPARATUS FOR AN ELECTRICALLY-POWERED AIR CONDITIONING COMPRESSOR

(71) Applicant: GM GLOBAL TECHNOLOGY OPERATIONS LLC, Detroit, MI (US)

(72) Inventors: Goro Tamai, Bloomfield Hills, MI (US); Marco A. Lopes, Rochester, MI (US); Suresh Gopalakrishnan, Troy, MI (US); Matthew Swift, Detroit, MI (US)

(73) Assignee: GM GLOBAL TECHNOLOGY OPERATIONS LLC, Detroit, MI (US)

(21) Appl. No.: 17/176,721

(22) Filed: Feb. 16, 2021

(51) Int. Cl. B60H 1/32; B60H 1/00

(52) U.S. Cl. CPC B60H 1/3205; B60H 1/00764; B60H 1/3229

(57) ABSTRACT

A vehicle system is described that includes a multi-phase rotary electric motor rotatably coupled via a rotatable member to an air-conditioning compressor, and a remotely located rechargeable energy storage system (RESS). The RESS includes a first power inverter that is electrically coupled to the multi-phase rotary electric motor via a plurality of electric power cables, a second power inverter that is electrically coupled to a second electric machine, a DC power source, and a chiller. A controller is in communication with and controllably coupled to the first power inverter and the second power inverter. The controller is operative to control the first power inverter to operate the multi-phase rotary electric motor in an open-loop control scheme.

Electrified vehicles, including hybrid-electric vehicles and electric vehicles, may utilize electric power to operate accessory devices and systems. One accessory system is a heating, ventilation, and air conditioning (HVAC) system, which employs a refrigeration system that includes an electrically-powered air-conditioning (eAC) AC compressor.

Known eAC compressors include a compressor that is coupled to an electric motor that is connected to an electric inverter and integrated into a single package. Drawbacks of a fully integrated eAC compressor include challenges in packaging the device in an underhood location, and challenges related to developing and validating the physical and electrical integrity thereof.

There is a need to improve packaging flexibility, physical integrity, and electrical integrity of an eAC compressor.

### SUMMARY

The concepts described herein are systems and apparatuses related to implementation of an electrically-powered air-conditioning (eAC) compressor that is coupled to a multi-phase rotary electric motor that is powered employing a first power inverter, wherein the first power inverter is remotely located from the multi-phase rotary electric motor, thus enhancing packaging flexibility.

This includes a vehicle system having a multi-phase rotary electric motor rotatably coupled via a rotatable member to an air-conditioning (AC) compressor; and a rechargeable energy storage system (RESS). The RESS includes a first power inverter that is electrically coupled to the multi-phase rotary electric motor via a plurality of electric power cables, a second power inverter that is electrically coupled to a second electric machine, a DC power source, and a chiller. A controller is in communication with and controllably coupled to the first power inverter and the second power inverter.

The controller is operative to control the first power inverter to operate the multi-phase rotary electric motor in an open-loop control scheme.

An aspect of the disclosure includes the first power inverter being composed of a first plurality of power switches, and the second power inverter composed of a second plurality of power switches. The first plurality of power switches and the second plurality of power switches are thermally coupled to a heat sink that is thermally coupled to the chiller.

Another aspect of the disclosure includes the heat sink being a liquid-cooled heat exchanger device that is thermally coupled to a chiller.

Another aspect of the disclosure includes the controller in communication with a first plurality of gate drivers that are operatively coupled to the first plurality of power switches, and in communication with a second plurality of gate drivers that are operatively coupled to the second plurality of power switches. The first plurality of power switches and the second plurality of power switches are electrically coupled via a shared power bus to the DC power source.

Another aspect of the disclosure includes the multi-phase rotary electric motor not having a rotational position sensing device. Instead, the controller is operative to control the first power inverter to operate the multi-phase rotary electric motor in an open-loop control scheme without rotational position feedback from the multi-phase rotary electric motor.

Another aspect of the disclosure includes the RESS being located remotely from the multi-phase rotary electric motor.

Another aspect of the disclosure includes a vehicle system that includes a multi-phase rotary electric motor coupled via a rotatable member to an air-conditioning (AC) compressor; and a first power inverter electrically coupled to the multi-phase rotary electric motor via a plurality of electric power cables. The first power inverter is located remotely from the multi-phase rotary electric motor; and the multi-phase rotary electric motor does not include a rotational position sensing device capable of monitoring the multi-phase rotary electric motor.

Another aspect of the disclosure includes the multi-phase rotary electric motor being a three-phase brushless permanent magnet rotary electric motor.

Another aspect of the disclosure includes a vehicle drive unit being electrically coupled to a second power inverter. The first power inverter is collocated with the second power inverter.

Another aspect of the disclosure includes the first power inverter sharing a DC power bus in common with the second power inverter.

Another aspect of the disclosure includes a vehicle system including a multi-phase rotary electric motor rotatably coupled via a rotatable member to an air-conditioning (AC) compressor. A first power inverter is located remotely from the multi-phase rotary electric motor. The first power inverter is electrically coupled to the multi-phase rotary electric motor via a plurality of electric power cables. A controller is in communication with the first power inverter, and controls the first power inverter to operate the multi-phase rotary electric motor in an open-loop control scheme without rotational position feedback from the multi-phase rotary electric motor and without rotational position feedback from the eAC compressor.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an embodiment of an electrically-powered air-conditioning (eAC) compressor that is rotatably coupled to a multi-phase rotary electric motor that is powered by a remotely located first power inverter module (PIM), in accordance with the disclosure.

FIG. 2 schematically illustrates a mechanization for electric power distribution for a rechargeable energy storage system (RESS) that includes a remotely-located first power inverter module (PIM) and a second power inverter, in accordance with the disclosure.

FIG. 3 schematically illustrates an electrical power circuit for a first power inverter module (PIM) and a second power inverter, in accordance with the disclosure.

FIG. 4 is an isometric view of details related to a mechanization for a RESS that includes an electric power inverter for remote control of a multi-phase rotary electric motor coupled to an eAC compressor, in accordance with the disclosure.

FIG. 5 schematically illustrates mechanization of a thermal management system for a RESS that includes a first power inverter module (PIM) and a second power inverter, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

Furthermore, there is no intention to be bound by any expressed or implied theory presented in the preceding introduction and summary or the following detailed description. It should be understood that throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

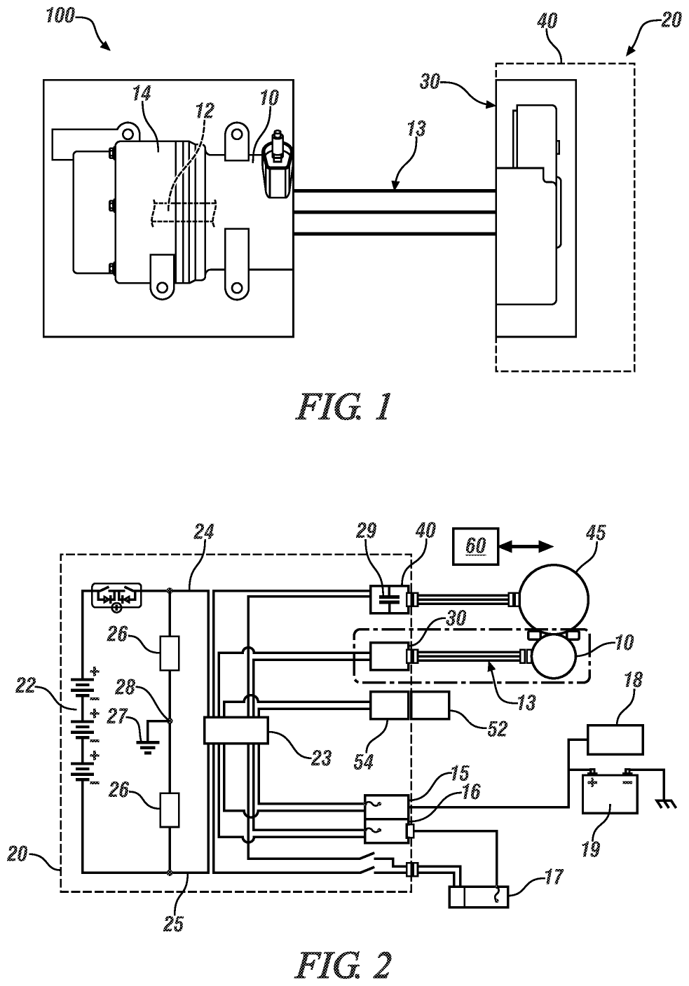

Referring to the drawings, wherein like reference numerals correspond to like or similar components throughout the several Figures, FIG. 1, consistent with embodiments disclosed herein, schematically illustrates a vehicle system 100 that includes an electrically-powered air-conditioning (eAC) compressor 14 that is rotatably coupled via a rotatable member 12 to a multi-phase rotary electric motor 10. The multi-phase rotary electric motor 10 is electrically coupled via electrical cables 13 to a first power inverter module (PIM) 30. The first PIM 30 is located remotely from the multi-phase rotary electric motor 10. In one embodiment, the remotely located first PIM 30 is an element of a remotely located rechargeable energy storage system (RESS) 20. Details of the RESS 20 are described with reference to FIGS. 2, 3, 4 and 5. The vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. In one embodiment, the eAC compressor 14 and multi-phase rotary electric motor 10 are arranged in an underhood location.

FIG. 2 schematically shows a mechanization drawing of the RESS 20 that illustrates electric power distribution between the RESS 20 and on-vehicle actuators including the multi-phase rotary electric motor 10 and a second electric machine 45. The RESS 20 is electrically coupled to and collocated with a high-voltage DC power source 22 that stores high-voltage DC electric power that is utilized by on-vehicle actuators. The RESS 20 is arranged to distribute electric power to the electric motor 10 via the first PIM 30, and is arranged to distribute electric power to the second electric machine 45 via a second power inverter (PIM) 40. In one embodiment, the second electric machine 45 is a drive unit that is part of a driveline that is capable of providing tractive effort for vehicle propulsion.

In one embodiment, and as illustrated, the high-voltage DC power source 22 supplies electric power to a terminal distribution block 23 via a shared high-voltage DC power bus that includes a positive high-voltage bus (HV+) 24 and a negative high-voltage bus (HV−) 25. Isolation impedance devices 26 are employed to electrically isolate HV+24 and HV−25 from a chassis ground 27. The isolation impedance devices 26 may include a pair of high-voltage DC link capacitors (capacitors) that electrically connect in series between HV+24 and HV−25, with a junction 28 that is electrically connected to a chassis ground 27. The capacitors preferably have the same capacitance, which is 3000 microfarads in one embodiment. The capacitors are selected to maintain electrical potential across HV+24 and HV−25, but may lack capacity to fully substitute for the DC power source 22. The isolation impedance devices 26 may further include resistors that electrically connect in parallel with the capacitors, including electrically connecting between HV+24 and HV−25 and at the junction 28. The second PIM 40 also includes a dc-link capacitor 29 that is arranged between HV+24 and HV−25. The RESS 20 may also include other circuit elements, including by way of example, an active DC bus discharge circuit including a resistor and a switch that electrically connect in series between HV+24 and HV−25. By arranging the RESS 20 to include the first PIM 30 and the second PIM 40, high-voltage filtering components such as the dc-link capacitor 29 and a discharge resistor may be shared, thus reducing component counts and freeing up packaging space.

The terminal distribution block 23 distributes electric power to the first PIM 30, second PIM 40, an RESS heating element 54, an auxiliary power module (APM) 15, and an on-board charging module (OBCM) 16.

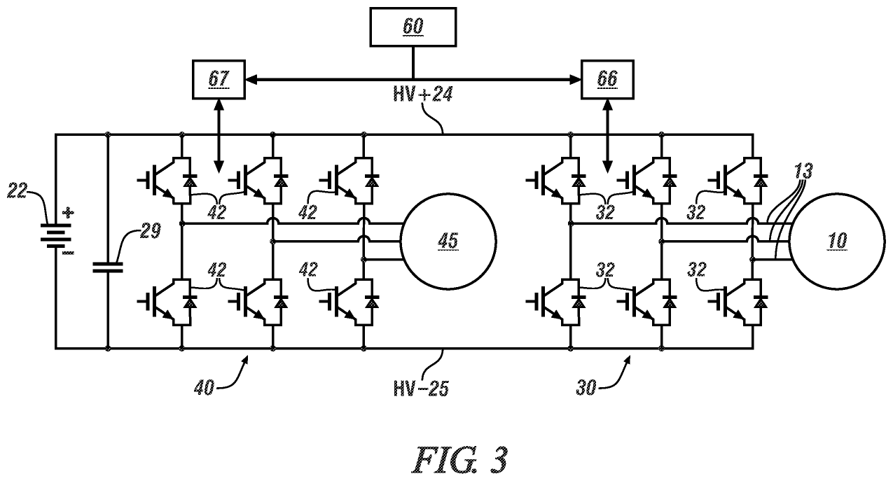

As illustrated with reference to FIG. 3, the first PIM 30 includes a plurality of power switches (EPI power switches) 32 that are complementary-paired and electrically connected in series between HV+24 and HV−25, with each of the EPI power switches 32 associated with one of the phases of the first PIM 30. Each of the EPI power switches 32 is a high-voltage switch, i.e., a semi-conductor device having low-on impedance that is in the range of milli-ohms in one embodiment. In one embodiment, the EPI power switches 32 are insulated gate bipolar transistors (IGBT). In one embodiment, the EPI power switches 32 are field-effect transistor (FET) devices. In one embodiment, the FET devices may be MOSFET devices. The EPI power switches 32 are configured as pairs to control electric power flow between HV+24, one of the electric cables 13 connected to and associated with one of the phases of the multi-phase electric motor 10, and HV−25. A controller 60 controls operations of the EPI power switches 32 via a first plurality of gate drivers 66.

The first plurality of gate drivers 66 are paired circuits that signally individually connect to one of the paired EPI power switches 32 of one of the phases to control operation thereof. Thus, the first plurality of gate drivers 66 includes three pairs of the gate drive circuits 66 or a total of six gate drive circuits 66 when the first PIM 30 and the electric motor 10 are three-phase devices. The plurality of gate drivers 66 receive operating commands from the controller 60 and control activation and deactivation of each of the EPI power switches 32 to provide motor drive functionality of the electric motor 10 that is responsive to the operating commands. During operation, each gate drive circuit 66 generates a pulsewidth-modulated signal in response to a control signal originating from the controller 60, which activates one of the EPI power switches 32 and permits current flow through a half-phase of the first PIM 30.

As illustrated with reference to FIG. 3, the second PIM 40 includes a plurality of power switches (PIM power switches) 42 that are complementary-paired and electrically connected in series between HV+24 and HV−25, with each of the PIM power switches 42 associated with one of the phases of the second electric machine 45. Each of the PIM power switches 42 is a high-voltage switch, i.e., a semi-conductor device having low-on impedance that is in the range of milli-ohms in one embodiment. In one embodiment, the PIM power switches 42 are insulated gate bipolar transistors (IGBT). In one embodiment, the PIM power switches 42 are field-effect transistor (FET) devices. In one embodiment, the FET devices may be MOSFET devices. The PIM power switches 42 are configured as pairs to control electric power flow between HV+24, one of the phases of the second electric machine 45, and HV−25. Controller 60 controls operations of the PIM power switches 42 via a second plurality of gate drivers 67. Alternatively, the system may employ a second controller to control operations of the PIM power switches 42 via the second plurality of gate drivers 67.

The second plurality of gate drivers 67 are paired circuits that signally individually connect to one of the paired PIM power switches 42 of one of the phases to control operation thereof. Thus, there are three pairs of the second plurality of gate drive circuits 67 or a total of six gate drive circuits 67 when the second PIM 40 and the second electric machine 45 are three-phase devices. The plurality of gate drivers 67 receive operating commands from the controller 60 and control activation and deactivation of each of the PIM power switches 42 to provide motor drive or electric power generation functionality that is responsive to the operating commands. During operation, each gate drive circuit 67 generates a pulsewidth-modulated signal in response to a control signal originating from the controller 60, which activates one of the PIM power switches 42 and permits current flow through a half-phase of the second PIM 40.

Referring again to FIG. 2, the RESS heating element 54 includes electrical resistive elements to generate heat using electrical power, and is electrically connected between HV+24 and HV−25.

The APM 15 is a step-down inverter that converts high-voltage DC electric power supplied from the high-voltage DC power source 22 via HV+24 and HV−25 to low-voltage electric power to charge a low-voltage DC power source 19, e.g., a 12V battery. The low-voltage DC power source 19 and associated battery charging circuit 18 may supply low-voltage electric power to on-vehicle systems such as infotainment systems, vehicle lighting, accessories, etc.

The OBCM 16 is configured to electrically couple to an off-board external power source via a charge receptacle 17 to effect electrical charging of the DC power source 22, such as when the vehicle is stationary.

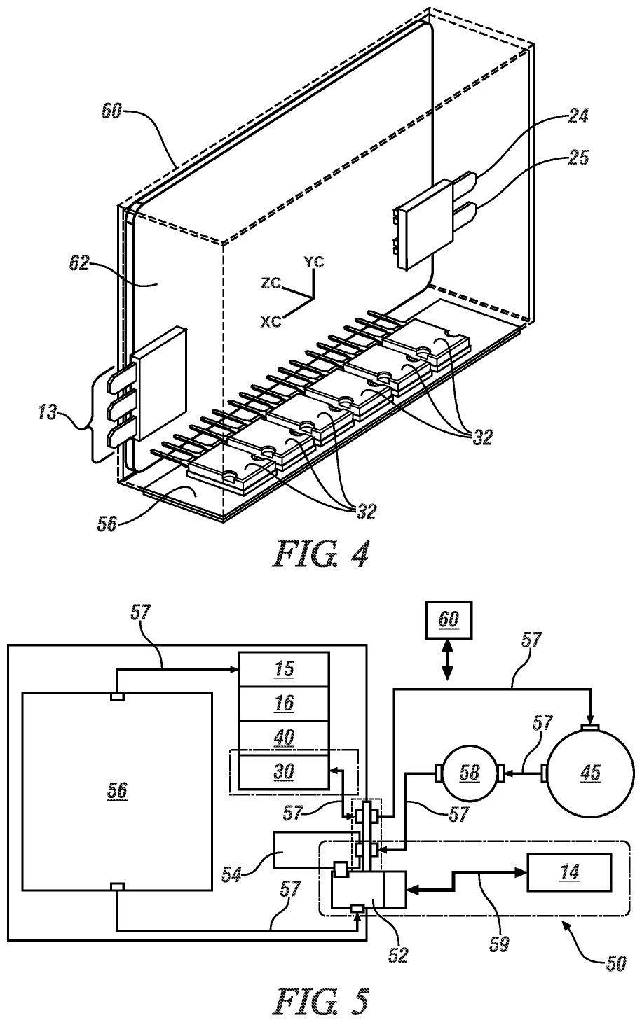

FIG. 4 schematically illustrates an isometric perspective of elements of the controller 60, with connections to HV+24 and HV−25, and connections to the electric cables 13. The controller 60 includes a circuit board 62, the EPI power switches 32 of the first PIM 30, and a plate-type heat exchanger 56. Although not illustrated, the controller 60 may also include the PIM power switches 42 of the second PIM 40 and gate drivers 66, 67, respectively, for the EPI power switches 32 and the PIM power switches 42. Each of the EPI power switches 32 is arranged such that a portion of the switch body is thermally coupled to the heat exchanger 56 for heat dissipation. In one embodiment, the PIM power switches 42 of the second PIM 40 are also thermally coupled to the heat exchanger 56. The controller 60 may also include one or multiple microprocessors, integrated circuits, discrete components, etc. that are employed in controlling and monitoring operation the various elements of the RESS 20.

The controller 60 controls electric power flow to the first PIM 30 via the gate drivers 66 to operate the multi-phase rotary electric motor 10 in an open-loop control scheme without rotational position feedback to power the compressor 14 in response to an operator or system command related to heating, ventilation, or cooling of a vehicle cabin, and absent rotational position feedback from the multi-phase rotary electric motor 10. Specifically absent from the electric motor 10 and from the compressor 14 is a rotational position sensor capable of monitoring rotational speed of the electric motor 10, the rotatable member 12, or the compressor 14. Specifically absent from the controller 60 is an electrical signal processing circuit that would be employed for processing a signal from a rotational position sensor. The circuit board 62 includes one or multiple processors, gate drivers 66, and other components.

The incorporation of the first PIM 30 into the RESS 20 enables integrated and combined cooling of the EPI power switches 32 of the first PIM 30 and PIM power switches 42, which may enable reduced component complexity and improved packaging flexibility as compared to a discrete system, and may facilitate use of a shared design of the eAC compressor 14 and electric motor 10 on multiple vehicle platforms.

FIG. 5 schematically shows a mechanization drawing to illustrate a cooling system 50 for heat management and thermal distribution in the RESS 20. The RESS 20 includes a chiller 52, which may be physically integrated into the RESS 20 and coupled via refrigerant lines 59 to the compressor 14 for circulating a liquid refrigerant to effect heat transfer therebetween. The chiller 52 is a heat exchange device that exchanges heat between the circulating liquid refrigerant and a circulating liquid coolant. A non-limiting example of a liquid refrigerant employed on-vehicle is R-134a (1,1,1,2-Tetrafluoroethane). A non-limiting example of a liquid coolant employed on-vehicle is ethylene glycol.

The circulating liquid coolant flows through one or multiple coolant circuits via a fluidic pump 58. The coolant circuits fluidically couple to the plate-type heat exchanger 56 via coolant lines 57 to effect heat transfer away from the EPI power switches 32 to the PIM power switches 42, the APM 15, and the OBCM 16. The coolant circuits may also fluidically couple via coolant lines 57 to the second electric machine 45.

An arrangement that includes an embodiment of the first PIM 30 being remotely located from the multi-phase rotary electric motor and compressor, and electrically coupled to the multi-phase rotary electric motor via a plurality of electric power cables may eliminate a need for integrating a high-voltage discharge circuit into the multi-phase rotary electric motor.

An arrangement that includes an embodiment of the first PIM 30 being remotely located from the multi-phase rotary electric motor may result in a smaller packaging envelope for the multi-phase rotary electric motor and compressor. Finding a suitable location for an eAC compressor with an integrated first PIM creates complexity costs since new tools and validation efforts are often required to modify the compressor housing to fit into available space.

An arrangement that includes an embodiment of the first PIM 30 being located in the RESS may mitigate or eliminate potential resonance issues between the first PIM 30 and the second PIM 40.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A vehicle system, comprising:
a multi-phase rotary electric motor rotatably coupled, as a first electric machine, via a rotatable member to an air-conditioning (AC) compressor; and
a rechargeable energy storage system (RESS), including:
a first power inverter, electrically coupled to the multi-phase rotary electric motor via a plurality of electric power cables,
a second electric machine;
a second power inverter, electrically coupled to the second electric machine,
a DC power source,
a chiller, and
a controller, in communication with and controllably coupled to the first power inverter and the second power inverter;
wherein the controller is operative to control the first power inverter to operate the multi-phase rotary electric motor in an open-loop control scheme.

2. The vehicle system of claim 1, wherein the first power inverter is composed of a first plurality of power switches, wherein the second power inverter is composed of a second plurality of power switches, and wherein the first plurality of power switches and the second plurality of power switches are thermally coupled to a heat sink that is thermally coupled to the chiller.

3. The vehicle system of claim 2, wherein the controller is in communication with a first plurality of gate drivers that are operatively coupled to the first plurality of power switches, wherein the controller is in communication with a second plurality of gate drivers that are operatively coupled to the second plurality of power switches;
wherein the first plurality of power switches and the second plurality of power switches are electrically coupled via a common power bus to the DC power source.

4. The vehicle system of claim 1, wherein the multi-phase rotary electric motor does not include a rotational position sensing device; and
wherein the controller is operative to control the first power inverter to operate the multi-phase rotary electric motor in an open-loop control scheme absent rotational position feedback from the multi-phase rotary electric motor.

5. The vehicle system of claim 1, wherein the RESS is located remotely from the multi-phase rotary electric motor.

6. A vehicle system, comprising:
a multi-phase rotary electric motor coupled via a rotatable member to an air-conditioning (AC) compressor; and
a first power inverter electrically coupled to the multi-phase rotary electric motor via a plurality of electric power cables;
wherein the first power inverter is located remotely from the multi-phase rotary electric motor; and
wherein the multi-phase rotary electric motor does not include a rotational position sensing device capable of monitoring the multi-phase rotary electric motor.

7. The vehicle system of claim 6, wherein the multi-phase rotary electric motor comprises a three-phase brushless permanent magnet rotary electric motor.

8. The vehicle system of claim 6, further comprising a vehicle drive unit electrically coupled to a second power inverter; wherein the first power inverter is collocated with a second power inverter that is coupled to a drive unit.

9. The vehicle system of claim 8, wherein the first power inverter shares a DC power bus with the second power inverter.

10. The vehicle system of claim 8,
wherein the first power inverter is composed of a first plurality of power switches;
wherein the second power inverter is composed of a second plurality of power switches; and
wherein the first plurality of power switches and the second plurality of power switches are thermally coupled to a heat sink.

11. The vehicle system of claim 10, wherein the heat sink comprises a liquid-cooled heat exchanger device thermally coupled to a chiller.

12. The vehicle system of claim 8,
wherein the first power inverter is composed of a first plurality of power switches;
wherein the second power inverter is composed of a second plurality of power switches; and
wherein the first plurality of power switches and the second plurality of power switches are electrically coupled to a DC power source via a single power bus.

13. A vehicle system, comprising:
a multi-phase rotary electric motor rotatably coupled via a rotatable member to an air-conditioning (AC) compressor;
a first power inverter, wherein the first power inverter is located remotely from the multi-phase rotary electric motor, and wherein the first power inverter is electrically coupled to the multi-phase rotary electric motor via a plurality of electric power cables, and
a controller, being controllably coupled to the first power inverter;
wherein the controller controls the first power inverter to operate the multi-phase rotary electric motor in an open-loop control scheme without rotational position feedback from the multi-phase rotary electric motor and without rotational position feedback from the AC compressor.

14. The vehicle system of claim 13, wherein the multi-phase rotary electric motor does not include a rotational position sensing device. P053838

15. The vehicle system of claim 13, wherein the first power inverter is collocated with a second power inverter that is coupled to a drive unit.

16. The vehicle system of claim 15, wherein the first power inverter shares a DC power bus with the second power inverter.

17. The vehicle system of claim 16, wherein the first power inverter is composed of a first plurality of power switches, wherein the second power inverter is composed of a second plurality of power switches, and wherein the first plurality of power switches and the second plurality of power switches are thermally coupled to a heat sink.

18. The vehicle system of claim 17, wherein the controller is in communication with a first plurality of gate drivers that are operatively coupled to the first plurality of power switches, wherein the controller is in communication with a second plurality of gate drivers that are operatively coupled to the second plurality of power switches; and
wherein the first plurality of power switches and the second plurality of power switches are electrically coupled via a power bus to a DC power source.

19. The vehicle system of claim 18, wherein the first plurality of power switches and the second plurality of power switches comprise one of Integrated Gate Bipolar Transistors (IGBTs) or Field Effective transistors (FETs).

20. The vehicle system of claim 13, wherein the multi-phase rotary electric motor comprises a three-phase brushless permanent magnet rotary electric motor.
